(19) United States
(12) Patent Application Publication
(10) Pub. No.: US 2003/0147620 A1
(43) Pub. Date: Aug. 7, 2003

(54) Germanuim-free silicate waveguide compositoins for enhanced L-band and S-band emission

(75) Inventors: Mark T. Anderson, Woodbury, MN (US); Craig R. Schardt, Saint Paul, MN (US); James R. Onstott, Dresser, WI (US); Kenton D. Budd, Woodbury, MN (US)

Correspondence Address: Attention: Nestor F. Ho, Office of Intellectual Property Counsel, 3M Innovative Properties Company, P.O. Box 33427, St. Paul, MN, 55133-3427, US

(73) Assignee: 3M Innovative Properties Company

(21) Appl. No.: 10/299,224

(22) Filed: Nov. 19, 2002

Related U.S. Application Data
(60) Provisional application No. 60/345,076, filed on Dec. 31, 2001.
(60) Provisional application No. 60/345,077, filed on Dec. 31, 2001.

(51) Int. Cl. G02B 6/00; G02B 6/16

(52) U.S. Cl. 385/142; 385/123

(57) ABSTRACT

A germanium-free co-doped silicate optical waveguide in accordance with the present invention includes a core material comprising silica, and oxides of aluminum, lanthanum, erbium and thulium, wherein the concentration of Er is from 15 ppm to 3000 ppm; Al is from 0.5 mol % to 15 mol %; La is less than 2 mol %; and Tm is from 150 ppm to 10000 ppm. In an exemplary specific embodiment the concentration of Al is from 4 mol % to 10 mol %; and the concentration of Tm is from 150 ppm to 3000 ppm. The core may further include F. In an exemplary embodiment, the concentration of F is less than or equal to 6 mol %. The waveguide may be an optical fiber, a shaped fiber or other light-guiding waveguides. An amplifier according to the present invention includes the optical fiber described above.

### RELATED APPLICATIONS

The present case is related to co-pending, commonly owned, concurrently filed U.S. Provisional Application Serial No. 60/345,077 entitled “Emission Silicate Waveguide Compositions For Enhanced L-Band and S-band Emission”; U.S. application Ser. No. 10/037,731, entitled “Method for Manufacturing Silicate Waveguide Compositions For Extended L-Band and S-Band Amplification”; and U.S. application Ser. No. 10/038,370, entitled “Silicate Waveguide Compositions For Extended L-Band and S-Band Amplification”, all of which are hereby incorporated by reference.

The present case is related to and claims priority from U.S. Provisional Application Serial No. 60/345,076, entitled “Germanium-Free Silicate Waveguide Compositions for Extended L-Band and S-Band Amplification”, having a filing date of Dec. 31, 2001.

### BACKGROUND OF THE INVENTION

The present invention relates to waveguides having a Germanium-free chemical composition that provides for extended lifetime and enhanced emission.

High-speed optical telecommunications via optical networks allow for the transfer of extremely large amounts of information through optical signals. As these optical signals travel over long distances or are coupled, manipulated, or directed by optical devices, the signals lose their strength. Signal attenuation may be caused by a number of factors, such as the intrinsic absorption and scattering in the transmission fiber, coupling losses, and bending losses. As a signal becomes weaker, it becomes more difficult to interpret and propagate the signal. Eventually, a signal may become so weak that the information is lost.

Optical amplification is a technology that magnifies or strengthens an optical signal. Optical amplification is a vital part of present-day high-speed optical communications.

Optical amplification is typically performed using devices (amplifiers) that contain a pump laser, a wavelength division multiplexer, isolators, gain shaping gratings, and an active rare-earth-doped optical fiber. The typical wavelength range at which present day optical networks—and optical amplifiers—operate is ˜1530-1570 nm, the so-called C-band. A band may be defined as a range of wavelengths, i.e., an operating envelope, within which the optical signals may be handled. A greater number of available bands generally translates into more available communication channels. The more channels, the more information may be transmitted.

Each band is identified with a letter denomination. Band denominations used in the present application are:

| Band | Wavelength Range |
|---|---|
| C- | ˜1530 to ˜1570 nm |
| L- | 1570 to ˜1605 nm |
| Extended L-band | 1570 to ˜1630 + nm |
| S-band | 1450 to 1530 nm |

Currently, high-speed internet-backbone optical fiber networks rely on optical amplifiers to provide signal enhancement about every 40-100 km. State-of-the-art commercial systems rely on dense wavelength division multiplexing (DWDM) to transmit ˜80 10 Gbit/second channels within a narrow wavelength band (e.g. C-band). Channels can be spaced ˜0.4 nm apart. These channels can be interleaved with forward and backward transmission (0.4 nm between a forward and backward directed channel) to provide multiterabit/second bidirectional transmission rates over a single fiber.

Recently, with the advent of L-band amplifiers, the optical transmission operating range has been extended from 1530-1565 nm to 1530-1605 nm—using both C- and L-band amplifiers, which provides up to 160 channels/fiber. There is a significant desire for even broader band operation to increase information throughput. Normally operation is limited to a maximum of ˜1605 nm by excited state absorption in the erbium-doped fiber. Operation is theoretically limited to ˜1650 nm in silicate-based fibers owing to high attenuation owing to multiphonon absorption at wavelengths greater than 1650 nm. Currently, operation is practically limited to ˜1630 nm in a fiber system owing to macrobending losses.

Future systems will potentially use wavelengths from 1450 to 1630 nm, which includes the so-called S-band. Use of the S-band has been demonstrated to nearly double the information carrying capacity of existing two stage C-+L-band systems. Transmissions of up to ˜10.5 Tb/s over a single fiber using a C-+L-+S-band configuration have been shown in a laboratory demonstration.

There are generally three approaches to optical amplification in the 1450-1630 nm region: Raman amplification, amplification with rare-earth-doped fiber amplifiers, and amplification that combines Raman and rare-earth-doped components.

Raman Fiber Amplifiers

Raman amplifiers rely on the combination of input photons with lattice vibration (phonons) to shift the pump light to longer wavelengths (Stokes shift). Amplification spectra are broad, but sometimes have unwanted sharp peaks. The process is inefficient, and requires a high power pump source. Such high power pumps include fiber lasers or a series of laser diodes, which can be quite costly. The process is nonlinear with incident intensity. Because it requires high input intensities, the process may lead to other unwanted nonlinear processes such as 4-wave mixing and self phase modulation. Nonetheless, Raman amplifiers are useful in combination with rare-earth-doped amplifiers to increase span lengths, especially for 10 Gbit/s and faster systems.

Rare-Earth-Doped Fiber Amplifiers

Rare-earth doped amplifiers rely on excitation of electrons in rare-earth ions by an optical pump and subsequent emission of light as the excited ions relax back to a lower energy state. Excited electrons can relax by two radiative processes: spontaneous emission and stimulated emission. The former leads to unwanted noise, the latter provides amplification. Critical parameters for an amplifier are its spectral breadth, noise, and power conversion efficiency (PCE). The latter two parameters correlate with excited state lifetime of the rare-earth ions: longer lifetimes lead to lower noise and higher PCEs. Spectral breadth in the fiber in the C-band, which determines how many channels can be simultaneously amplified in the C-band, correlates with the full-width-half maximum (FWHM) of the spontaneous emission spectrum of the rare-earth-doped glass.

The majority of commercial amplifiers are based on fibers in which the core glass comprises erbium-doped silicates that contain either aluminum and lanthanum (SALE—(silicon, aluminum, lanthanum, erbium)) or aluminum and germanium (SAGE). Of the two traditional fiber types, SAGE provides slightly greater spectral width, which allows for additional channels. SALE fiber generally provides slightly higher solubility of rare earth ions, which enables shorter fibers to be used. This is advantageous to minimize, for example, polarization mode dispersion. SALE and SAGE fibers typically provide amplification in the C- or L-bands, but this leaves a large portion of the low-loss region of the silica transmission fiber unused, namely the S-band and long wavelength portion of the extended L-band region (>1610 nm).

In the S-band, rare-earth doped fiber amplifiers typically rely on non-silicate thulium (Tm)-doped glasses. Thulium provides a relatively broad emission that is centered at ˜1470 nm. The energy levels of thulium are such that multiphonon processes can easily quench this transition, especially in high phonon energy hosts such as silica. For this reason, lower phonon energy glasses such as heavy-metal oxides (e.g. germanate, tellurite and antimonate glasses) and especially fluoride glasses such as “ZBLAN” are preferred as hosts for the thulium. These non-silicate glasses tend to be difficult to fiberize and splice to existing transmission fiber and to date have limited commercial applications.

In the extended L-band, rare earth doped fibers typically are heavy-metal oxide or fluoride-based. Examples of heavy-metal oxide glasses are those based on tellurium oxide and antimony oxide. Both of these types of glasses are difficult to splice owing to their low melting points and high refractive indices.

In the S- and extended L-band, researchers have worked on an optical amplifier approach using a fiber with a core containing simultaneously erbium and thulium. Unexamined Korean Patent Application; No. 10-1998-00460125 mentions a fiber having a core comprising SiO₂, P₂O₅, Al₂O₃, GeO₂, Er₂O₃, Tm₂O₃ (SPAGET). The Er and Tm ions are in the range of 100-3000 ppm and the core can optionally contain Yb, Ho, Pr, and Tb in addition to Er and Tm. The reference further speaks about a cladding that contains SiO₂, F, P₂O₅, and B₂O₃.

An Er—Tm codoped silica fiber laser has been reported. The laser contained a fiber having a SiO₂—Al₂O₃—GeO₂—Er₂O₃—Tm₂O₃ core (SAGET) and was pumped at 945-995 nm to obtain emission from Er (˜1.55 μm), Tm (˜1.85-1.96 μm) or both depending upon the parameters of mirrors in the laser cavity, fiber length, pump rate, and pump wavelength. Two fibers were reported. In the first fiber the Er/Tm concentrations were 6000/600 ppm. In the second the concentrations were 1200/6000 ppm. The numerical apertures (NAs) were ˜0.27 and ˜0.12, respectively. The second mode cutoff was ˜1.4 μm in both. The first fiber exhibited lasing (gain), but the second did not.

An amplified spontaneous emission (ASE) light source has been reported that contains Er and Tm and which exhibits significant emission enhancement in the S-band region compared to sources that contain erbium only. The reported fiber contained an SiO₂—Al₂O₃—GeO₂—Er₂O₃—Tm₂O₃ core (SAGET) and contained two levels of Er/Tm. In the first fiber the Er/Tm concentrations were 1200/6000 ppm. In the second the concentrations were 300/600 ppm. The NAs of the fibers were 0.2 and 0.22 respectively. In both cases an ˜90 nm FWHM forward ASE peak was observed from ˜1460-1550 nm. The second fiber had an ASE about 5 dB higher than the first.

Finally, L-band amplifier modules have been reported that contain two separate fiber types, one doped only with erbium and one doped only with thulium. The fibers are coupled together. The thulium-doped fiber absorbs a portion of the light emitted from the erbium-doped fiber and modifies the gain slope.

Given the ever increasing demand for broadband services, it is highly desirable to have a single amplifier, compatible with silicate transmission fiber, that has significant gain at wavelengths between 1570 and ˜1630 nm, i.e., extended L-band. An extended L-band amplifier operating to ˜1630 nm would enable greater than 50% more channels compared to a conventional L-band amplifier. Thus, there is a desire for silicate-based fibers that provide substantial emission in the extended L-band. It is also desirable to have an economical, S-band amplifier that is compatible with the current fiber infrastructure. A desirable fiber amplifier would provide longer lifetime and/or increased emission intensity compared to existing amplifiers along the desired bands.

Er—Tm glass families in the literature (SAGET and SPAGET) contain germanium. Ge-containing glasses, especially those with Tm, are more prone to photodarkening from blue or ultra-violet (UV) light than glasses without Ge (W. S. Brocklesby et. al “Defect Production in Silica Fibers Doped with Tm3+”, Optics Letters, 18(24), 1993, 2105-2107). It is well known that Tm-doped glasses can emit blue light via upconversion processes. It would thus be desirable to formulate glasses free of germanium that exhibit enhanced normalized emission in the extended L-band relative to standard Er-doped fiber.

### SUMMARY OF THE INVENTION

The present invention relates to a germanium-free glass composition and waveguide that exhibits enhanced normalized emission in the extended L-band relative to standard Er-doped fiber.

A germanium-free co-doped silicate optical waveguide in accordance with the present invention includes a core material comprising silica, and oxides of aluminum, lanthanum, erbium and thulium, wherein the concentration of Er is from 15 ppm to 3000 ppm; Al is from 0.5 mol % to 15 mol %; La is less than 2 mol %; and Tm is from 150 ppm to 10000 ppm. In an exemplary specific embodiment the concentration of Al is from 4 mol % to 10 mol %; and the concentration of Tm is from 150 ppm to 3000 ppm. Note that “mol %” refers to mole percent on a cation basis unless otherwise stated. Also, “ppm” refers to parts per million on a cation basis unless otherwise stated.

The core may further include F. In an exemplary embodiment, the concentration of F is less than or equal to 6 anion mol %.

The waveguide may be an optical fiber, a shaped fiber or other light-guiding structure. An amplifier according to the present invention includes the optical fiber described above.

An embodiment includes a core comprising at least two regions, wherein at least one region contains a substantially different Er to Tm ratio than at least one other. The regions may be in an annular arrangement. The core may be made by MCVD, sol-gel and/or soot deposition, solution doping, and consolidation processes.

### BRIEF DESCRIPTION OF THE DRAWINGS

FIG. 1 is a graph of differential normalized spontaneous emission at 1610 nm vs Er³⁺⁴I_{13/2} average lifetime for six different SALET glasses in accordance with the present invention.

FIG. 2 is a graph of differential normalized spontaneous emission at 1630 nm vs Er³⁺⁴I_{13/2} average lifetime for the six different SALET glasses in accordance with the present invention.

FIG. 3 is a graph of differential normalized spontaneous emission at 1650 nm vs Er³⁺⁴I_{13/2} average lifetime for the six different SALET glasses.

FIG. 4 is a schematic cross-sectional diagram of an exemplary optical fiber in accordance with the present invention.

### DETAILED DESCRIPTION OF THE INVENTION

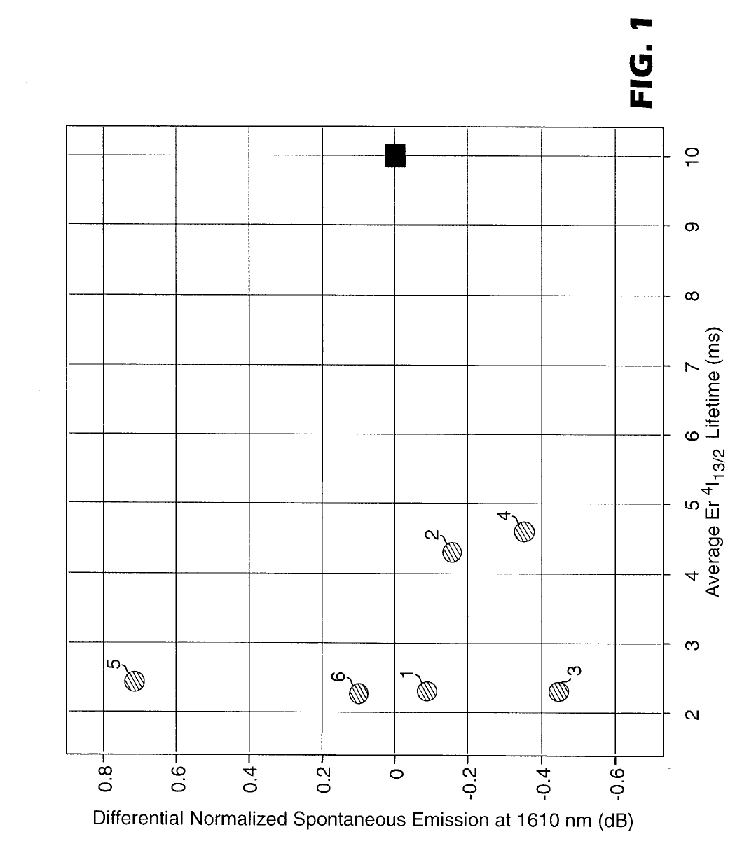

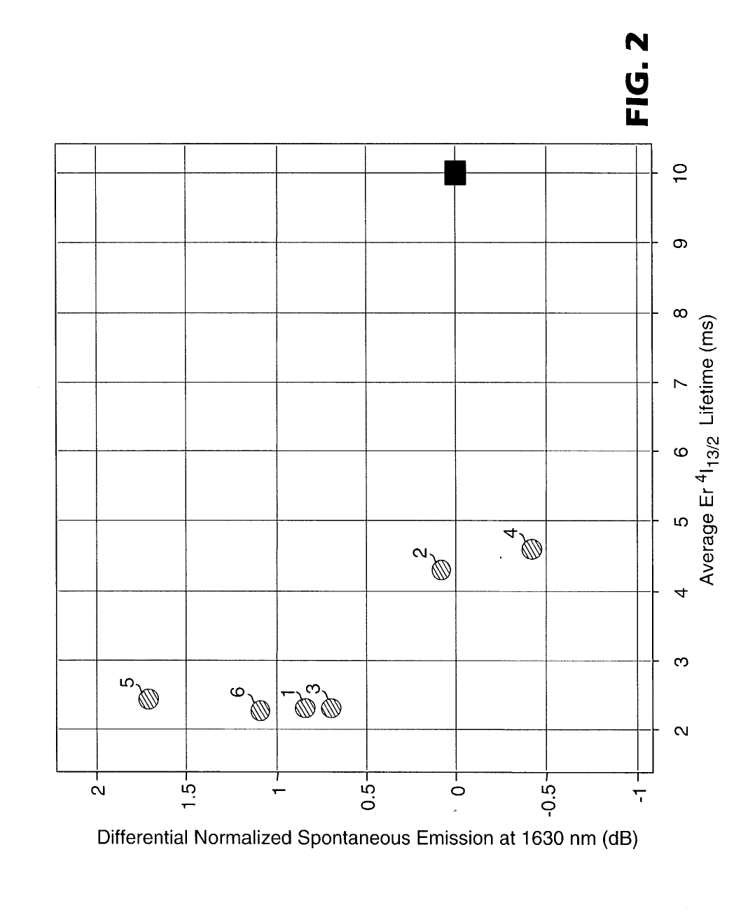

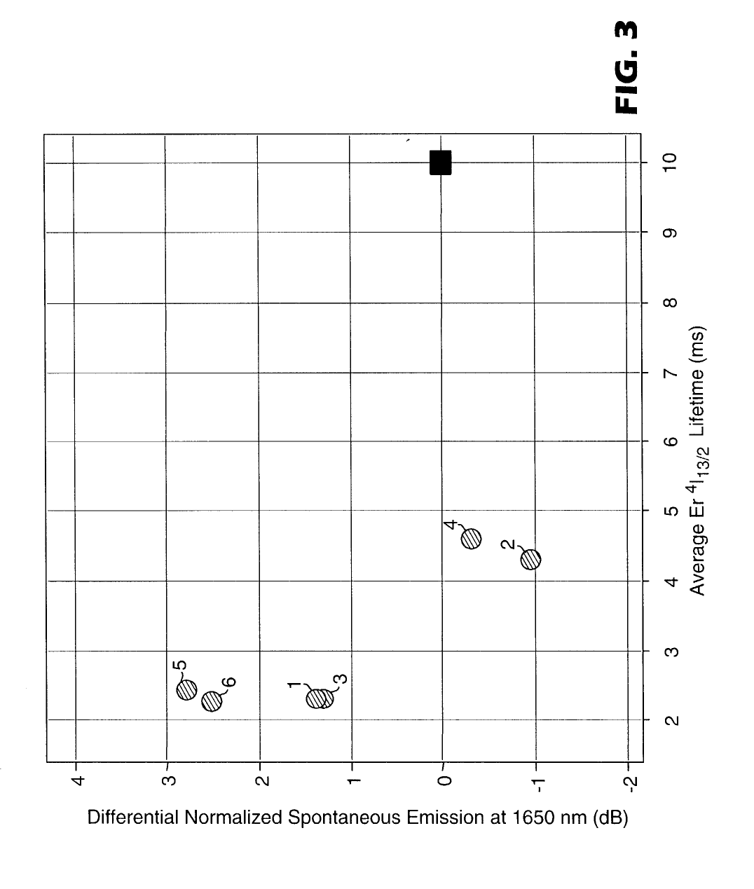

FIG. 1 is a graph of differential normalized spontaneous emission at 1610 nm vs Er³⁺⁴I_{13/2} average lifetime for six different SALET glasses. The intensity of the spontaneous emission at 1600 nm is no less than −8.8 dB relative to the maximum emission intensity at ˜1.53 μm and wherein the intensity of the spontaneous emission at 1650 nm is no less than −14.4 dB relative to the maximum emission intensity at ˜1.53 μm. FIG. 2 is a graph of differential normalized spontaneous emission at 1630 nm vs Er³⁺⁴I_{13/2} average lifetime for the same six SALET glasses. FIG. 3 is a graph of differential normalized spontaneous emission at 1650 nm vs Er³⁺⁴I_{13/2} average lifetime for the same six SALET glasses. Numbers correspond to sample numbers in Example 1. The box is a SALE glass, such as that available from 3M Company, St. Paul, Minn.

FIGS. 1-3 show that it is possible to obtain an enhanced normalized emission from SALET glass as compared to standard erbium-doped SALE glass. The magnitude of the enhancement depends on the exact composition of the host and the amount of thulium. The figures further show there is a tradeoff between emission intensity and lifetime. SALET compositions with relatively high concentrations of Tm tend to have high normalized emissions in the 1600-1650 nm region and relatively short average lifetimes. SALET compositions with relatively low concentrations of Tm tend to have lower normalized emissions and longer average lifetimes than SALET with high concentrations of Tm.

The lifetimes in the exemplified SALET glasses are nearly identical to SAGET glasses that have the same refractive index and contain the same amounts of Tm and Er. This suggests that, in several exemplary cases, La can be substituted for Ge with little effect on lifetime. The normalized emission of SALET can be greater or less than that of comparable SAGET glasses, again depending upon the details of the host composition and the Tm content.

Substitution of La for Ge (i.e. SALET vs SAGET) can be important for extended operating lifetime of a fiber. Ge is known to contribute to photodarkening in silicate glasses, in the presense of blue or UV light, whereas La has not been so implicated. Elimination of Ge could thus be important in long-lived or high power Tm-containing devices.

Optical fibers made with SALET glasses show the advantages stated above.

An embodiment of a fiber in accordance with the present invention has an inner cladding that is free of boron and contains Si, O, P, F. Boron increases the sensitivity of Ge toward short-wavelength-induced formation of photodefects. A preform that contains B in the inner cladding results in a fiber with some boron in the core after draw owing to diffusion at high temperature. It is known that Tm-doped silicate fibers can emit short wavelength light owing to upconversion processes. Thus, the boron can make a Ge—Tm-containing fiber more sensitive to photodefects and photodarkening caused by upconverted short wavelength light. The present invention mitigates this effect by providing a boron free fiber.

In yet another embodiment, the Er and Tm concentrations vary independently within the core of a fiber or waveguide. This results in different concentrations or Er/Tm ratios at different points or regions within a core. There can be continuous variation in Er and Tm content or multiple discrete regions having different Er and Tm content. By “region” is meant a point for which the volume of material sufficiently large to allow the glass composition to be defined or determined. Typically, a region would be greater than about 10,000 nm³. Such designs can provide longer excited state lifetimes. For example, close contacts of Er and Tm that can lead to inter-ion energy exchange and short lifetimes can be reduced.

In one particular embodiment, waveguides or fibers according to the present invention have radial gradations of Er and Tm concentrations, wherein the respective concentration maxima do not occur at the same radial distances. This may be accomplished by the use of multiple core deposition layers, each with different Er/Tm ratios.

In yet another embodiment, the waveguide or fiber core is segmented into Er-rich and Tm-rich regions, such as by using radial or longitudinal segmentation. This may be accomplished by deposition of alternating annular regions that are relatively rich in Er and relatively rich in Tm respectively.

The above described embodiments are amenable to sol-gel, MCVD, or solution-doping approaches, or combinations thereof.

Another optical fiber in accordance with the present invention contains fluorine in the core, which can help solubilize rare earth ions such as erbium and thulium and thus reduce pair induced quenching effects, for example in erbium.

The present invention may be better understood in light of the following examples.

### EXAMPLES

Exemplary Composition 1:

The waveguide glass of the present exemplary embodiment may be generically described as:

SARE_{A}RE_{B1}RE_{B2}, where

S, silica, is the base glass present in approximately >75 mol %.

A, aluminum oxide. Without wishing to limit the present invention, aluminum oxide is believed to act as an index raiser and rare-earth ion solubilizer; generally, increasing concentrations of aluminum oxide increase the normalized emission intensity, especially from ˜1600-˜1620 nm and decrease the average lifetime.

RE_{A} is a non-emissive rare earth oxide that contains non-emissive RE_{A} ions. The oxide acts as an index raiser. Rare-earth ions in the oxide buffer active rare earth ions and can be used to mediate active rare-earth ion-ion interactions. The RE_{A} cations can have an additional role in that if it is used as a substitute for Ge, it may help produce materials that have less tendency to form photodefects.

RE_{B1} is a rare earth oxide that contains active RE_{B1} ions such as Er. The oxide is an index raiser. The active RE_{B1} cations can be pumped alone or co-pumped; Er can be pumped at 800, 980, 1480 nm.

RE_{B2} is a rare earth oxide that contains active RE ion such as Tm. The oxide is an index raiser. The RE_{B2} cations can be co-pumped or resonantly excited; Tm can be pumped at 800 or 1000-1200 nm.

F, fluorine, acts as an index depresser; solubilized rare earth ions.

Optical Data on Bulk Samples

Photoluminescence data was obtained using a fiber pump/collection scheme. A bead of the appropriate glass composition was held via electrostatic forces on the end of a horizontally aligned optical fiber. An x-y translator was used to manipulate the bead within close proximity of the cleaved end of a fiber carrying the pumping wavelength (the pump fiber). Bead position was optimized for maximum fluorescence emission, which was monitored with an optical spectrum analyzer (OSA). The mounting and initial alignment operations were viewed under an optical microscope. The pump laser (typically 980 nm) was coupled to the pump fiber via a wavelength division multiplexer (WDM). The light emitted in the 1450-1700 nm range was collected with the pump fiber and monitored via an OSA.

Normalized emission was determined as follows: the normalized value (in dB) at the specified wavelength for a standard SALE fiber was subtracted from the normalized value in dB at that wavelength for the experimental glass. The SALE fiber was standard erbium doped amplifier fiber, such as that available from 3M Company, St. Paul, Minn.

Emission decay curves were collected by pulsing the source light at ˜10 Hz and monitoring the decay of the emission intensity. The emission decay curves were normalized and fit with a double exponential fit using standard software. From the decay curve analyses, it was possible to determine upper state lifetimes (slow and fast) of the excited state electrons and the relative percentages of each. Three independent fitting parameters were used in the double exponential analysis: constant for the slow Er radiative decay, τ_{slow}, constant for the fast Er radiative decay, τ_{fast}, and the relative percentages of the two lifetimes α.

1/τ_{average}=α*1/τ_{fast}+(1−α)*1/τ_{slow}

Using the McCumber theory, the absorption spectrum was predicted from the emission spectrum. The absorption spectra were then used to calculate Giles parameters, which are utilized in common models for optical amplifiers. The Giles parameters allowed for accurate composition designs for optical fiber manufacturing.

Silica Stock Solution

Tetraethoxysilane (223 mL, available from Aldrich Chemical Company, Milwaukee, Wis.); absolute ethanol (223 mL, available from Aaper Alcohol, Shelbyville, Ky.); deionized water (17.28 mL); and 0.07 N hydrochloric acid (0.71 mL) were combined in a 2-L reaction flask. The resulting transparent solution was heated to 60° C. and stirred for 90 minutes. The solution was allowed to cool and was transferred to a plastic bottle and stored in a 0° C. freezer. The resulting solution had a concentration of 2.16 M (i.e. moles/liter) SiO₂.

### Example 1

### Three Hosts with Four Er/Tm Ratios for Extended L-band

Erbium-thulium codoped silicate glass beads were prepared with three types of hosts and four Er/Tm levels. To prepare the beads, 2.16 M partially hydrolyzed silica stock solution, 1.0 M aluminum chloride hydrate in methanol, 0.5 M lanthanum nitrate hydrate in methanol, 0.1 M erbium chloride hydrate in methanol, and 0.1 M thulium nitrate hydrate in methanol were combined in a container. The reagents were mixed so as to give a solution that yielded gels with the compositions (in mol %) shown in Table 1 below.

TABLE 1

| Sample | Er/Tm | SiO₂ | AlO_{1.5} | LaO_{1.5} | ErO_{1.5} | TmO_{1.5} |
|---|---|---|---|---|---|---|
| 1 | 10/20 | 92.86 | 6.14 | 0.55 | 0.15 | 0.03 |
| 2 | 10/2 | 92.96 | 6.04 | 0.82 | 0.15 | 0.30 |
| 3 | 3/20 | 92.90 | 6.10 | 0.65 | 0.045 | 0.03 |
| 4 | 3/2 | 93.01 | 5.99 | 0.93 | 0.045 | 0.30 |
| 5 | 10/20 | 92.00 | 7.00 | 0.55 | 0.15 | 0.03 |
| 6 | 10/2 | 89.00 | 10.00 | 0.55 | 0.15 | 0.30 |

All compositions were batched such that the refractive index was ˜1.4800, which, with a silicate cladding in an optical fiber, would provide numerical aperture ˜0.25. Compositions 1-6 were added to a mixture of methanol (250 mL) and 29 weight percent aqueous ammonium hydroxide (50 g). The resulting solutions were stirred until they gelled (about 10 seconds). The gels were isolated by suction filtration. The gels were heated at 80° C. overnight to dry the samples. The dried samples were ground with a ceramic mortar and pestle to reduce the aggregate size to less than 150 micrometers. The ground samples were transferred to alumina boats (Coors) and calcined at 950° C. for about 1 hour in static air to densify and remove all organics.

After grinding in a ceramic mortar with a ceramic pestle, the resulting calcined particles were gravity fed into a hydrogen/oxygen flame. The H₂/O₂ ratio in the flame was 5:2. The particles were jetted by the flame onto a water-cooled aluminum incline with a collection trough at the bottom. Glass beads and un-melted particles from each fraction were collected in the trough.

Fluorescence spectra and lifetime data were obtained by the use of the general procedure described above and are shown in FIGS. 1-3.

To prepare a SALET fiber, a hollow synthetic fused silica tube is cleaned, such as by an acid wash, to remove any foreign matter. The tube is mounted in a lathe for deposition of the inner layers. Several high purity silica-based layers are deposited by chemical vapor deposition (so-called MCVD) by passing a hydrogen/oxygen flame across the tube while flowing SiCl₄, POCl₃, and SiF₄ inside the tube. The innermost layer contains a high concentration of fluorine (e.g. ˜4 mol %).

The core of the preform is formed by the solution doping method. A porous silica layer is deposited by MCVD and then infiltrated with a solution that contains Al, La, Er, and Tm ions. After deposition of the core, the tube is dried, consolidated, and collapsed into a seed preform.

Subsequent thermal processing is performed to adjust the core-to-clad ratio to achieve a desired core diameter in the final fiber. Such subsequent processing may involve multiple stretch and overcollapse steps. The completed preform is then drawn into an optical fiber. The preform is hung in a draw tower. The draw tower includes a furnace to melt the preform, and a number of processing stations, such as for coating, curing and annealing.

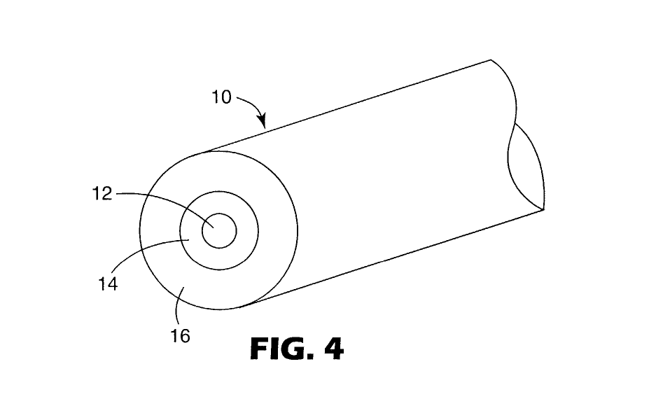

FIG. 4 illustrates schematically an optical fiber 10 according to the present invention. The fiber 10 includes a core 12, an inner cladding 14, and an outer cladding 16, each respectively concentrically surrounding the other. An exemplary optical fiber in accordance with the present invention includes a core material comprising silica, and oxides of aluminum, lanthanum, erbium and thulium, and a lower refractive index cladding material surrounding the core material. The core concentrations for an exemplary fiber are:

the concentration of Er is from 15 ppm to 3000 ppm;

the concentration of Al is from 0.5 mol % to 12 mol %; preferably 4 mol % to 10 mol %;

the concentration of La is less than or equal to 2 mol %;

the concentration of Tm is from 150 ppm to 10000 ppm; preferably 150 ppm to 3000 ppm.

The waveguides of the present invention offer significant advantages. Exemplary waveguides in accordance with the present invention, (1) exhibit enhanced extended L-band emission, (2) may contain an additional non-active rare earth to mediate the Er—Tm interaction and make a more efficient and tailorable amplifier, (3) are free of germanium, (4) may contain ions that inhibit photodarkening, (5) may contain fluorine, which helps solubilize rare earth ions in the matrix.

Those skilled in the art will appreciate that the present invention may be used in a variety of optical waveguide and optical component applications. While the present invention has been described with a reference to exemplary preferred embodiments, the invention may be embodied in other specific forms without departing from the spirit of the invention. Accordingly, it should be understood that the embodiments described and illustrated herein are only exemplary and should not be considered as limiting the scope of the present invention. Other variations and modifications may be made in accordance with the spirit and scope of the present invention.

What is claimed is:

1. A waveguide comprising:
a) a germanium-free core material comprising silica, and oxides of aluminum, lanthanum, erbium and thulium, and a lower refractive index cladding material surrounding the core material, wherein;
b) the concentration of Er is from 15 ppm to 3000 ppm;
c) the concentration of Al is from 0.5 mol % to 15 mol %;
d) the concentration of La is from 0.5 mol % to 2 mol %; and
e) the concentration of Tm is from 150 ppm to 10000 ppm.

2. The waveguide of claim 1, wherein
a) the concentration of Er is from 150 ppm to 1500 ppm;
b) the concentration of Al is from 4 mol % to 10 mol %; and
c) the concentration of Tm is from 150 ppm to 3000 ppm.

3. The waveguide of claim 1, wherein the concentration of Er is from 150 ppm to 1500 ppm.

4. The waveguide of claim 1, wherein the concentration of Al is from 2 mol % to 8 mol %.

5. The waveguide of claim 1, wherein the concentration of Tm is from 15 ppm to 3000 ppm.

6. The waveguide of claim 1, the core further comprising F.

7. The waveguide of claim 6, wherein the concentration of F is less than or equal to 6 anion mol %.

8. The waveguide of claim 1, wherein the waveguide is a co-doped silicate optical fiber.

9. The waveguide of claim 1, wherein the waveguide is a shaped fiber.

10. An amplifier including the waveguide of claim 1.

11. The waveguide of claim 1, said core comprising at least a first and a second region, wherein the first region contains a substantially different Er to Tm ratio than the second region.

12. The waveguide of claim 11, wherein said regions are in an annular arrangement.

13. The waveguide of claim 11, wherein the core is made with multiple MCVD passes.

14. The waveguide of claim 11, wherein the core is made with multiple sol-gel passes.

15. The waveguide of claim 11, wherein the core is made with multiple soot deposition, solution doping, and consolidation passes.

16. A silicate optical fiber comprising:
a) a germanium-free core comprising silica, and oxides of Al, Er, La, and Tm;
b) the concentration of Er is from 15 ppm to 3000 ppm;
c) the concentration of Al is from 0.5 mol % to 15 mol %;
d) the concentration of La is from 0.5 mol % to 2 mol %; and
e) the concentration of Tm is from 150 ppm to 10000 ppm.

17. The optical fiber of claim 16, wherein
a) the concentration of Er is from 150 ppm to 1500 ppm;
b) the concentration of Al is from 4 mol % to 10 mol %; and
c) the concentration of Tm is from 150 ppm to 3000 ppm.

18. The optical fiber of claim 16, wherein the intensity of the spontaneous emission at 1600 nm is no less than −8.8 dB relative to the maximum emission intensity at ˜1.53 μm and wherein the intensity of the spontaneous emission at 1650 nm is no less than −14.4 dB relative to the maximum emission intensity at ˜1.53 μm.

19. The optical fiber of claim 16, the core further comprising F, wherein the concentration of F is less than or equal to 6 anion mol %.

20. An amplifier including the optical fiber of claim 16.

21. The optical fiber of claim 16, said core comprising at least a first and a second region, wherein the first region contains a substantially different Er to Tm ratio than the second region.

22. The optical fiber of claim 21, wherein said regions are in an annular arrangement.
